(19) United States
(12) Patent Application Publication
(10) Pub. No.: US 2016/0093133 A1
(43) Pub. Date: Mar. 31, 2016

(54) Multi-Station Electronic Gaming Table With Shared Display and Wheel Game

(71) Applicant: Bally Gaming, Inc., Las Vegas, NV (US)

(72) Inventors: Bryan M. Kelly, Alamo, CA (US); Daniel L. Pisano, Pleasanton, CA (US); Martin S. Lyons, Las Vegas, NV (US)

(21) Appl. No.: 14/862,911

(22) Filed: Sep. 23, 2015

Related U.S. Application Data
(60) Provisional application No. 62/055,370, filed on Sep. 25, 2014.

(51) Int. Cl. G07F 17/32

(52) U.S. Cl. CPC G07F 17/322; G07F 17/3272; G07F 17/3209; G07F 17/3211; G07F 17/3293

(57) ABSTRACT

An electronic gaming table is set forth which includes a large, shared touch screen video display for plural players including players at opposite margins of the table. A controller controls the display define video real estate for each of a plurality of player user interfaces at player stations at opposite margins of the display where the user interfaces are property oriented. Players may wager using their user interface and the controller is configured to discriminate between different interfaces. A shared game may be a concentric video wheel game including concentric wheels which randomly present Poker holdings along radial pay lines. Player may wager on individual pay lines or upon all pay lines.

### CROSS-REFERENCE TO RELATED APPLICATION

This application claims priority to U.S. Provisional Patent Application Ser. No. 62/055,370 filed Sep. 25, 2014 and titled: “Wagering Games and Method”.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Electronic game machines are well known in the art. Often they are free-standing machines whereby a single player may play one or more games. It is also known to provide community game feature most typically as a bonus for the stand alone machines. A large “bank” video display is provided and upon qualification or one or more triggering events occurring on a machine of a bank of machines, the players participate in a community game displayed at the bank display for all of the players to see.

Community or shared games provide excitement to the players as they share in the excitement of a successful outcome and commiserate with an unsuccessful outcome. It would be advantageous to provide a community or shared game for one or more players which offers the excitement of video Poker without the element of play strategy which can intimidate some players. There is also a need for a game presentation format which promotes shared play of a game in an informal setting.

### SUMMARY OF THE INVENTION

There is, therefore, provided according to the present invention a shared gaming experience for two or more players which presents an environment to highlight the shared experience. There is also presented a shared game feature.

Toward this end there is provided a table which includes a base supporting a substantially horizontal table top. A large, shared, polygonal touch screen video display is disposed at the table top to define at each of at least two opposing margins video real estate for at least one player station wherein the video display is controlled to arrange each player station at a correct point of view orientation and perspective for a player thereof. Real estate at the video display is also defined for the display of a shared game. Each defined player station includes one or more touch screen defined buttons for the player to input a wager and to interact with the shared game. A game controller is configured to control the shared video display to display outcomes for the shared game and is in communication with each of said defined player stations to receive and discriminate between inputs from different player stations.

In an embodiment the video display is rectangular and player stations are defined proximate each corner of the polygonal touch screen video display.

In an embodiment the controller is configured to control the video display to display at the video real estate therefore, a concentric wheel game where each wheel displays symbols and the displayed symbols along radial positions define outcomes for the game. In a specific embodiment the controller controls the display to display five concentric wheels displaying graphics representing playing cards and the radial positions shared by the concentric wheels define Poker holdings.

### BRIEF DESCRIPTION OF THE DRAWINGS

These and other features and advantages will become better understood with reference to the Description and Drawings wherein;

FIG. 1A is a top view of an embodiment of the table according to an embodiment of the present invention showing the display of a shared, wheel, game and player stations;

FIG. 1B is a front view of the gaming table of FIG. 1;

FIG. 2 is an enlarged view of a display of the shared game;

FIG. 3 is a logic diagram for the play of the game of FIG. 1;

FIGS. 4 and 5 illustrate a user interface for the game;

FIGS. 6A-6C illustrate an example of a pay schedule for the play of the game of FIG. 1;

FIGS. 7A and 7B are a block diagram of the physical and logical components of the gaming table of FIG. 1B;

FIG. 8 is a block diagram of the logical components of a gaming kernel in accordance with one or more embodiments; and

FIGS. 9A and 9B are a schematic block diagram showing the hardware elements of a networked gaming system in accordance with one or more embodiments.

### DETAILED DESCRIPTION

Persons of ordinary skill in the art will realize that the following description of the invention described in Appendix A and further enabled herein is illustrative only and not in any way limiting. Other embodiments of the invention will readily suggest themselves to such skilled persons having the benefit of this disclosure.

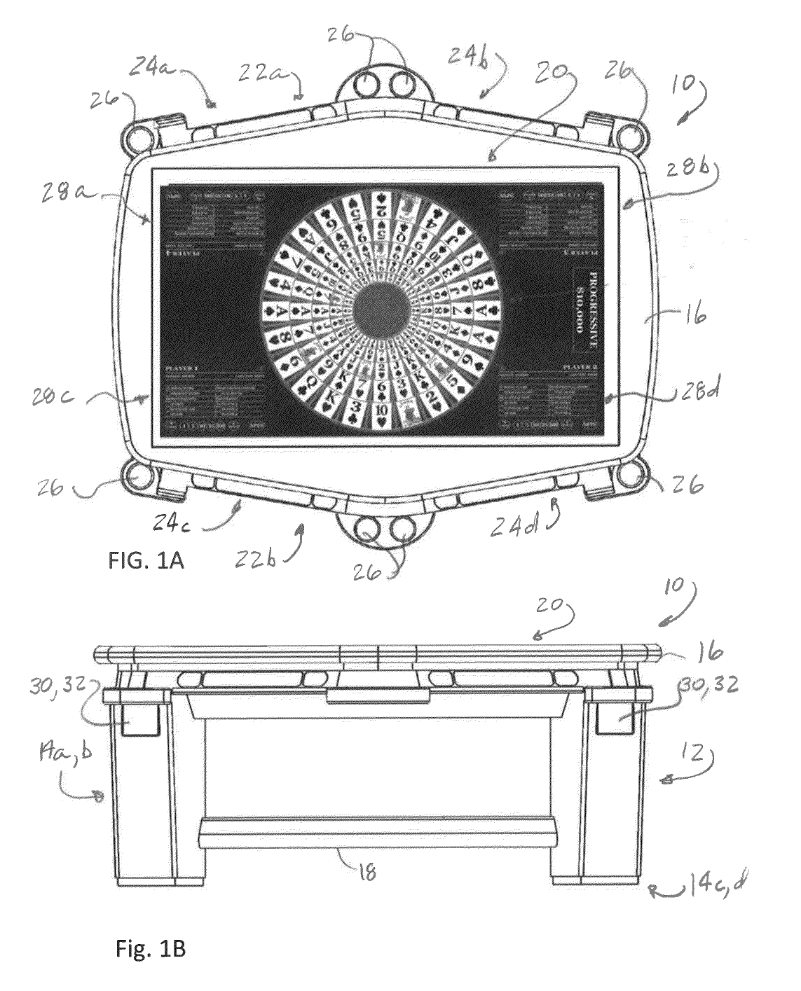

Turning to FIGS. 1A-1B there is shown a top view of a shared gaming table 10 according to an embodiment of the present invention. The gaming table 10 has a base 12 with four upstanding legs 14a-d supporting a table top 16 arranged substantially horizontally. One or more horizontal braces 18 may further provide support for the table 10. Mounted at the table top 16 to be substantially horizontal is a large, shared, touch-input enabled video display 20. The video display 20 is polygonal and may be square of, as shown, rectangular having, for example, a diagonal dimension of approximately 65 inches. Preferably the video display 20 is a high definition video display such as a 4 K Ultra HD display (3840×2160) 65″ diagonal video display.

The video display 20 and table top 16 define opposing margins 22a, b in the long dimension. Disposed at the margin 22a are two spaced player stations 24a, b and disposed at opposing margin 22b are player stations 24c, d. The player stations 24a-d are adapted to accommodate players seated around the table 10 for playing the game and for interacting with the video display 20. Each player station 24-d may be bracketed by cup holders 26 to assist in defining the boundaries for the player stations 24a-d. As can be appreciated from FIG. 1A players at player stations 24a, b face, across the table top 16 and video display, the players seated at player stations 24c, d.

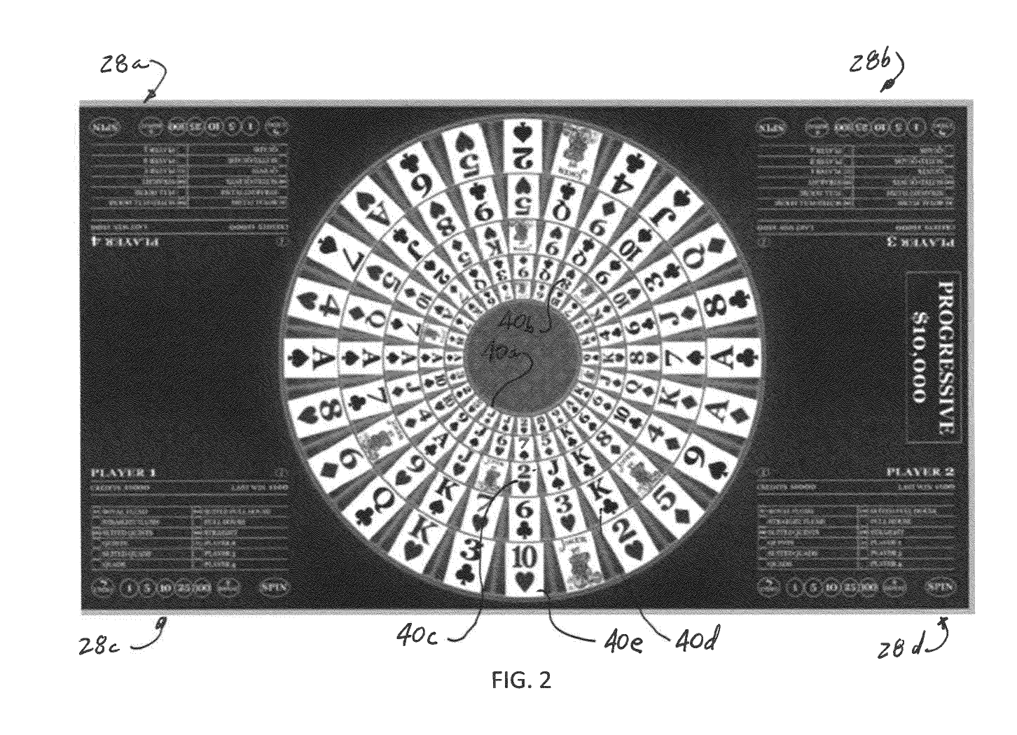

To accommodate the plural players for the shared game seated at two or more player stations 24a-d, the shared video display 20 is controlled to allocate display real estate to each player for a touch screen enabled user interface 28a-d as well as to define game real estate proximate the center of the video display 20 for the shared game. As shown in FIG. 1A and FIG. 2 the user interfaces 28a-d are defined proximate the corners of the video display 20 and are each associated with a corresponding player station 24a-d. As can also be appreciated the video display 20 is controlled such that each user interface 28a-d is properly oriented for the player. As shown in FIG. 1A the user interfaces 28a, b are shown what would be upside down to the players at the opposing margin 22b of the table 10 but are correctly shown as right side up to the players at player stations 24a, b at margin 22a. Similarly the video display 20 touch screen functionality is adapted to discriminate between touches may at individual user interfaces 28a-d. Preferably the player stations 24a-d are spaced apart along the margins 22a, b to facilitate touch discrimination as we as preventing one player from trespassing on another player's user interface 28a-d either inadvertently or for malevolent purposes.

Each player station 24a-d may include other player input apparatus such as a currency and voucher reader 30 and a card reader 32 for reading a player loyalty card. The currency and voucher readers 30 enable players to establish credit value at their player stations 24a— for waging on the shared game. Electro-mechanical buttons (not shown) may also be provided at each player station 24a-d. Each player station 24a-d may also be provided with a ticket printer (not shown) for printing value tickets when a player cashes out from the game. The card readers 32 enable the reading of player loyalty cards for identifying the player and for reading employee cards for gaining authority to provide maintenance/access to the table 10.

Inasmuch as the players seated at the opposing margins 22a, b of the gaming table 10 have opposing points of view, the shared game provided according to an embodiment of the invention should have a universal point of view; that is the game display should not appear to be upside down to certain players. Accordingly there is presented in an embodiment of the present invention a spinning wheel game of the type now described. As best shown in FIG. 2 the video display 20 is controlled to display a spinning wheel game which includes five concentric wheels 40a, e each wheel populated by symbols for the game. The video display 20 is controlled to display the symbols such that they align along radial positions (hereinafter also referred to a pay lines) from the innermost wheel 4a to the outmost wheel 40e to define, along these radial positions, one or more outcomes. In an embodiment the symbols can be playing card symbols such that the outcomes are five card Poker holdings along one or more pay lines. As shown each wheel 40a-e is displayed to include twenty four cards and thereby twenty-four radial pay lines.

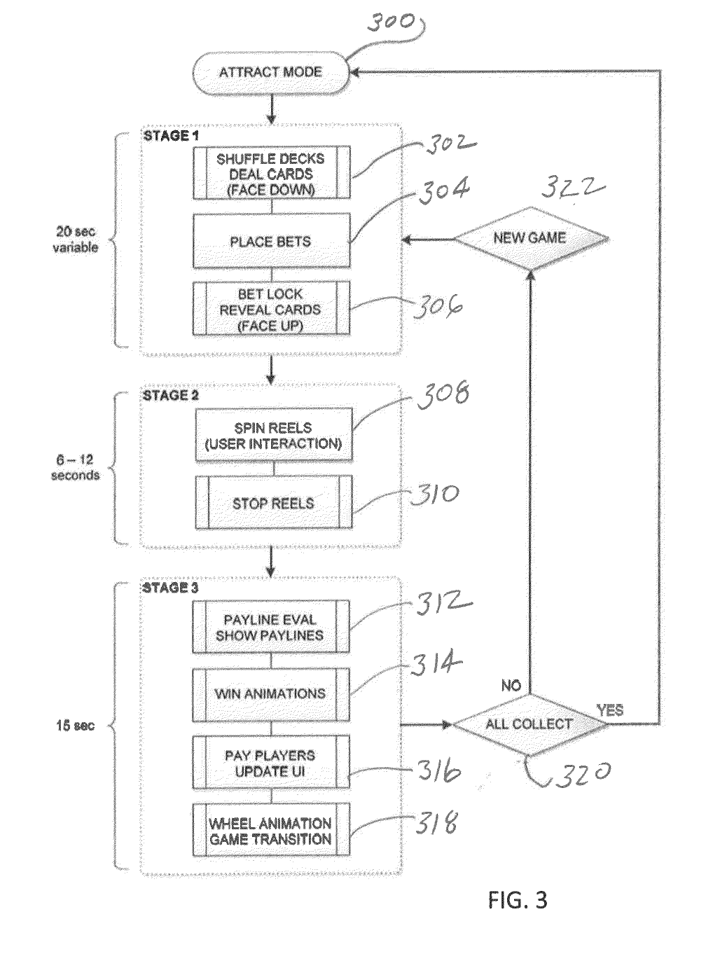

FIG. 3 is a logic diagram showing the operation of the exemplary game. At 300 the gaming table 10 video display 20 is controlled to display an attract mode. The attract mode may be simulated games producing interesting outcomes or other video and graphic presentations. After one or more players has established credit value for wagering at the table 10, the gaming table processor (described below) at 302, using a random number generator, randomly selects for each wheel 40a-e twenty four playing cards. Preferably the cards selected to populate each when 40a-f are randomly selected from data representing a separate deck of cards for each wheel. In this embodiment each wheel 40a-e will include cards selected from a data structure representing a deck of fifty-three playing cards, a standard deck of fifty-two playing cards plus one Joker which is wild. At the same time the processor starts a timer countdown and controls the video display to display that each player has a configurable period of time such as twenty seconds to make a wager. To represent the playing cards at this stage before revealing an outcome, the video display 20 may be display card backs at each card symbol position on the wheels 40a-e. Each game randomly re-draws from the fifty-three card data structure for each wheel 40a-e.

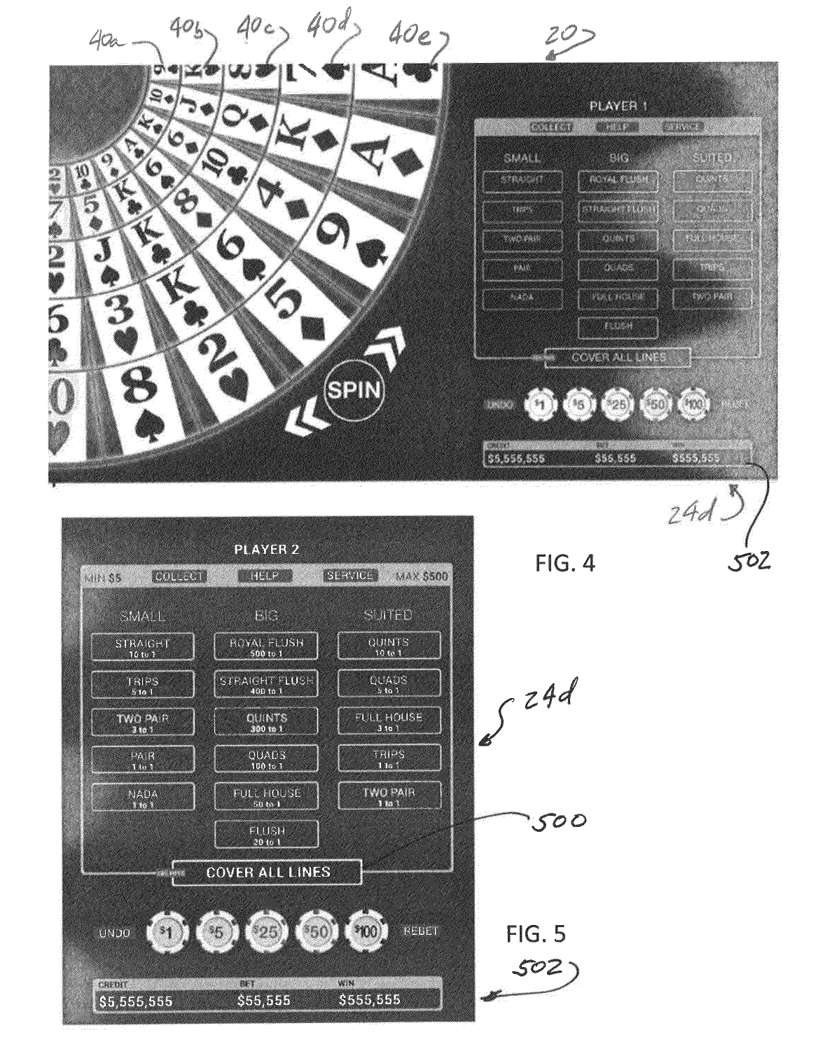

To make a wager each player at their user interface 28a-d displayed at the display 20 has displayed there at the user interface as shown at FIGS. 4 and 5 depicting only user interface 24d. The player selects one or more denominations of virtual chips from, for example, five value denominations of $1, $5, $25, $50 and $100. While not shown the value established by the player for play may allocate the value as virtual chips stacked representing denominations. A play may “break” the value of virtual chip by touching the stack and then touching or dragging the chip to another stack. For example a player may touch a $25 virtual chip and drag it to the $5 stack whereupon the $25 chip is broken into five $5 chips. Displayed adjacent to the virtual chips at the user interface is a pay table to inform the player of the awards for certain outcomes. There is also a betting location 500 which may be denoted “COVER ALL LINES” to provide a location for the player to register a wager covering all pay lines for the game. Meters 502 at each user interface 24a-d also display the current value of credits available for wagering, the size of the player's bet and a win meter to show amounts won on any game.

Returning top FIG. 3, at 304 and during the time period allotted, each player places their desired wager(s). Certain bets may be mandatory such as an ante wager to wager on all twenty-four pay lines. This wager may be made by the player touching the virtual chip stacks for the desired wager amount(s) and then touching the desired proposition such as touching the cover all lines location 500 to bet on all pay lines and/or one or more radial pay lines presented wheels 40a-e. As stated above the player may make the ante coverall wager as well as, in an embodiment, wager on one or more individual pay lines. According to an embodiment players may be required to place the ante wager for all pay lines. A minimum ante wager may be required. Players may also wager on one or more individual pay lines. Players may wager on groups of pay lines or adjoining pay lines. For example, the player may desire to wager in six pay lines, those pay lines may be randomly determined or may represent the pay lines most nearly associated with the player's user interface 28a-d. In an embodiment the payer may select all, one or six pay lines. To wager on a pay line the player selects the amount of the wager represented by the virtual stack of chips and touches the desired pay line(s) on the game display. In an embodiment the player may touch and drag and drop the wager by dragging their finger to move virtual chips onto the desire wager proposition. At the end of the allotted wagering period at 306, which is configurable, the playing cards for the wheels 40a-e are revealed and a player may be prompted to touch and spin the wheels 40a-e as suggested in FIG. 4. At 308 the designated player swipes their finger/hand or touches a button at the video display 20 which prompts the controller to control the video display to display the wheels 40a-e spinning. At 310 the controlled controls the video display 20 to show the wheels 40a-e stopping. The spin and stopping action may encompass a configurable time such as six to twelve seconds to build anticipation. The stopping of the wheels 40a-d may be sequential, random or substantially simultaneous. In a preferred embodiment the stopping of the outer wheel 40e is delayed to build anticipation of the outcome. At 312 the radial pay lines are evaluated against data in a data structure storing data representing winning outcomes. As described below winning outcomes are based upon familiar rankings of Poker hands. To highlight winning outcomes at 314 the video display 20 is controlled to display win animations such as highlighting winning outcomes along on one or more pay lines or outlining the winning pay lines. At 316 all winning wagers are paid to the players which successfully wagered upon winning propositions and wagers for all losing propositions are collected. At 318 after collecting losing wagers and paying winning wagers the video display 20 is controlled to display a transition animation to prepare for the next game. If all players have cashed out from the game or lost their credit value and no value is established to continue play at 320 the game is returned to the attract mode 300. If there are players who wish to play another game at 322 a new game phase is initiated. The phase of evaluating the pay lines, animating the winning outcomes, paying and collecting wagers as shown in FIG. 3 can extend over a configurable period of about fifteen seconds.

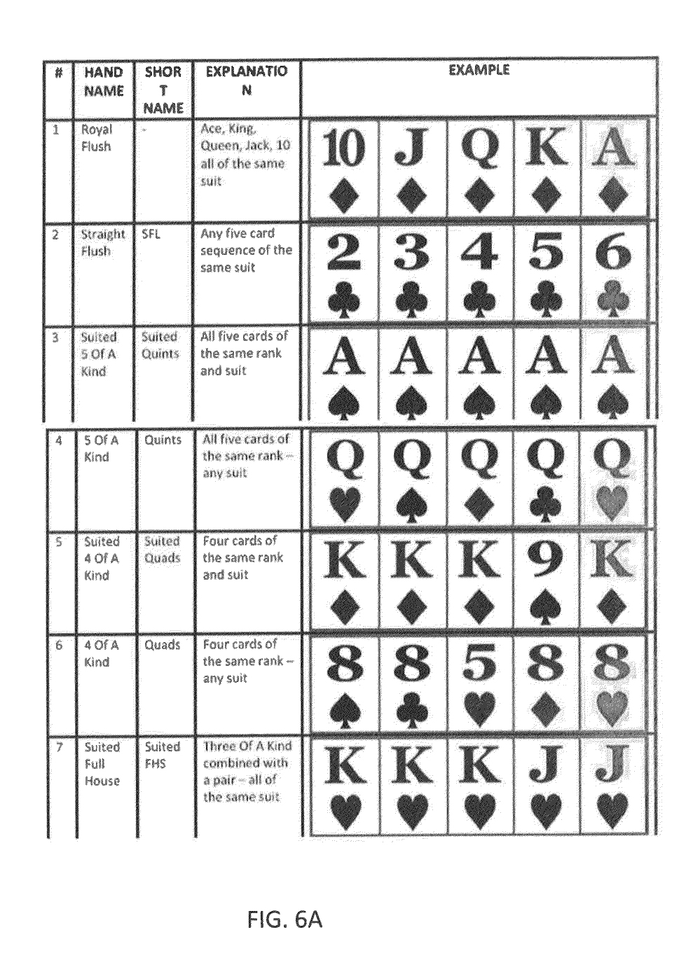

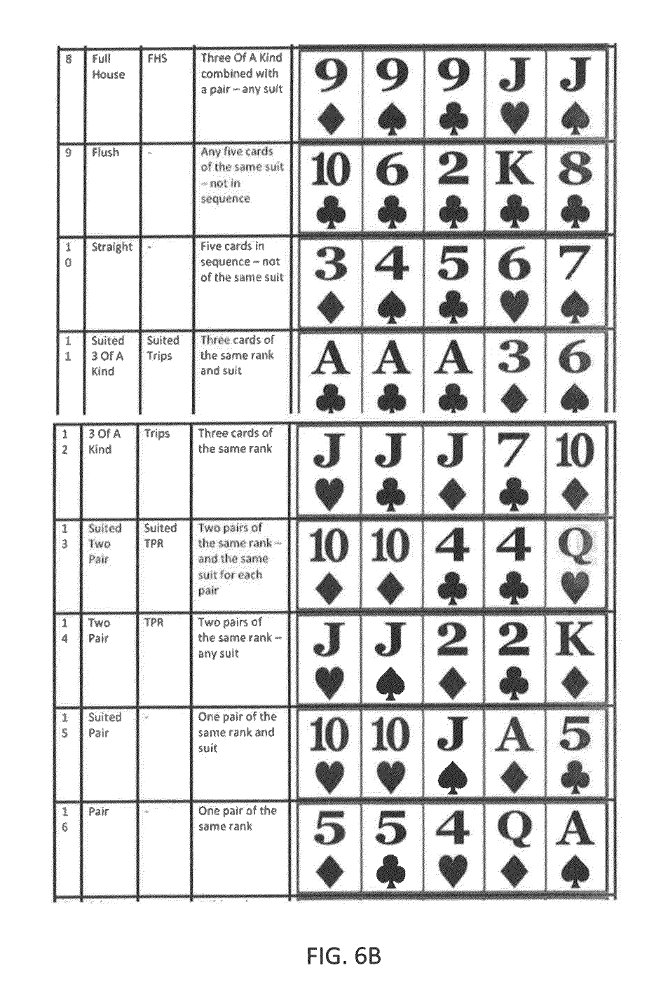

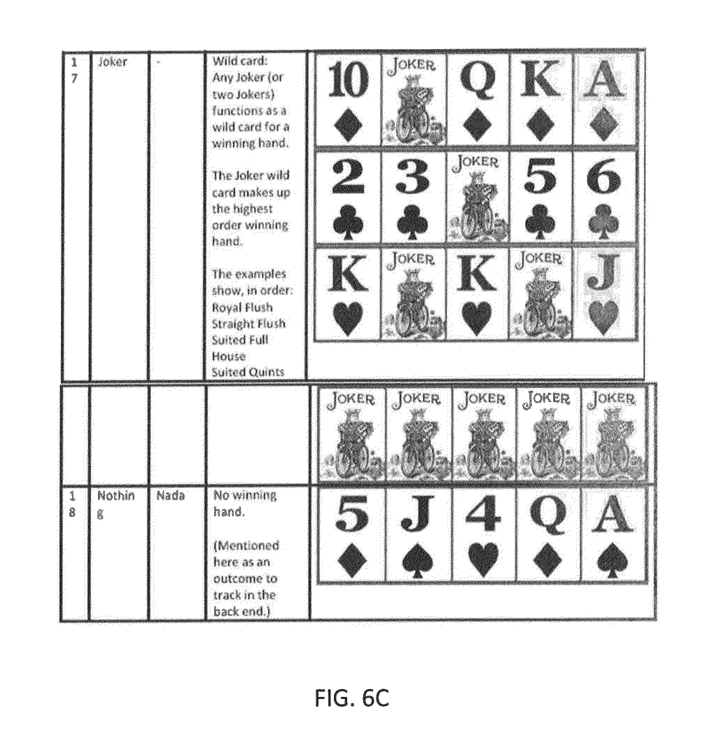

FIGS. 6A-6C depict an example of a pay table which may apply to an embodiment of the game. The table shows in column 1 hand rankings, column 2 the Poker holding, column 3 a shorthand name for the Poker holding, column 4 a description of the holding and an example of the playing cards constituting the holding. FIG. 5 shows an example of the awards for such holdings. For example, if a player wagered $1 on a pay line which resulting in a holding suited 4-of-a-kind such as K♦ K♦ K♦ 9 [symbol] K♦, the player would be paid $5 for having Suited Quads (four K♦). Only the highest ranked outcome of any pay line is awarded. Winning hands to have to be in sequential order; however certain jackpot outcomes such as progressive awards may be defined by sequential outcomes (radially inward or radially outward). In an embodiment players may be offered a “No Winning Outcome” wager which wins if no radial pay line includes a winning outcome.

In further embodiments the number or frequency of Jokers appearing can be varied to adjust the volatility for the game.

A Rebet button enables the player to make the same wager(s) on consecutive games and an Undo button enables the player to undo a wager.

In an embodiment the game may include a Progressive Jackpot such as one or more Royal Flushes, sequential Royal Flushes (in sequence radially inward or outward), and five Jokers and to which a portion of wagers is contributed. In a further embodiment the game may include a secondary or bonus game triggered by a mystery event or by an outcome of the game. Still further the symbols for the wheels 40a-e may be symbols other than cards such as slot machine symbols, dice, dominoes or other symbols.

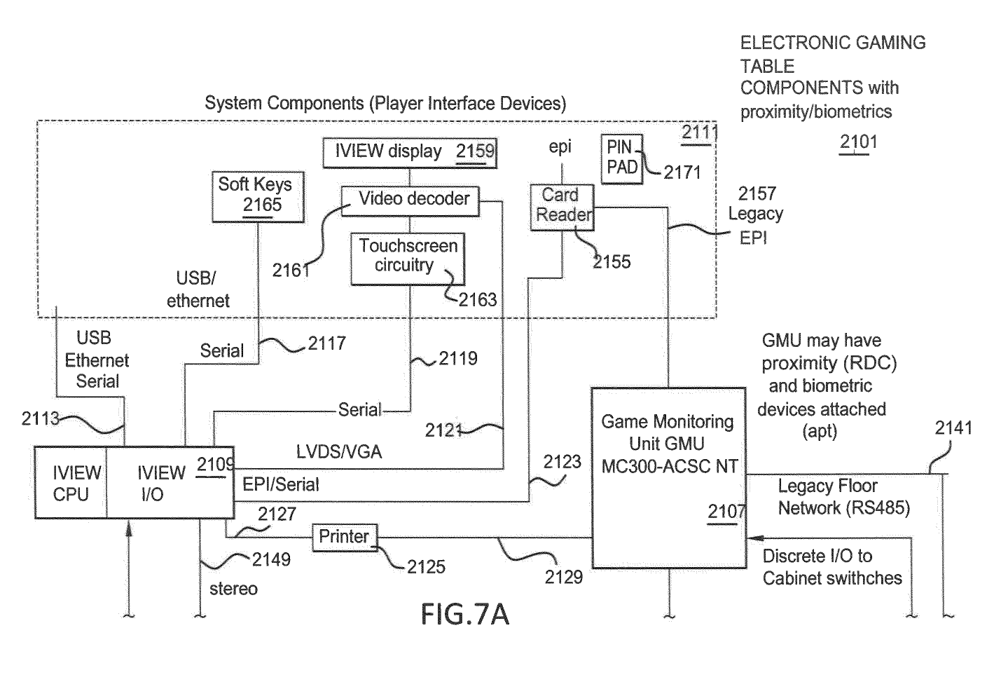

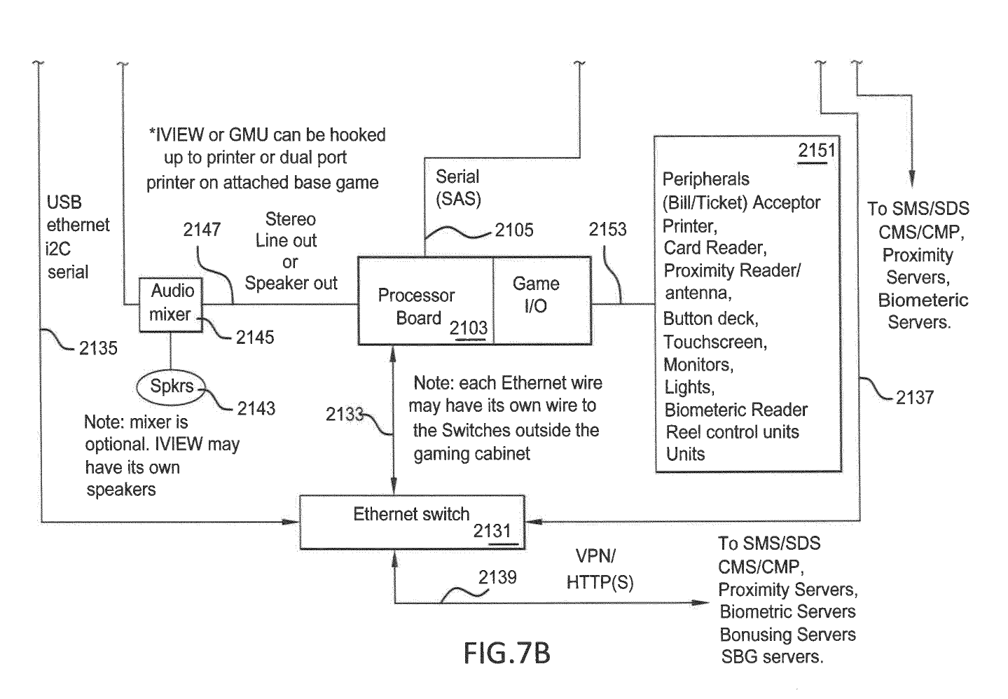

Referring to FIGS. 7A and 7B, the structure of the electronic gaming table 10 is shown at 2101 accordance with one or more embodiments. Gaming table 10 includes an integrated circuit board 2103 (Processor Board) connected through serial bus line 2105 to game monitoring unit (GMU) 2107 (such as a Bally MC300 or ACSC NT), and player interface integrated circuit board (PIB) 2109 connected to player interface devices 2111 over bus lines 2113, 2115, 2117, 2119, 2121, 2123. A ticker printer 2125 is connected to PIB 2109 and GMU 2107 over bus lines 2127, 2129. Integrated circuit board 2103, PIB 2109, and GMU 2107 connect to Ethernet switch 2131 over bus lines 2133, 2135, 2137. Ethernet switch 2131 connects to a slot management system (SMS) and a casino management system (CMS) network over bus line 2139. GMU 2107 also may connect to the SMS and CMS network over bus line 2141. Speakers 2143 connect through audio mixer 2145 and bus lines 2147, 2149 to base game integrated circuit board 2103 and PIB 2109. The proximity and biometric devices and circuitry may be installed by upgrading a commercially available PIB 2109, such as a Bally iView™ unit. Coding executed on integrated circuit board 2103, PIB 2109, and/or GMU 2107 may be upgraded to integrate a game in accordance with one or more embodiments of the invention

Peripherals 2151 connect through I/O board 2153 to base game integrated circuit board 2103. For example, a bill/ticket acceptor 30 is typically connected to a game input-output board 2153 which is, in turn, connected to a conventional central processing unit (“CPU”) integrated circuit board 2103, such as an Intel Pentium microprocessor mounted on a gaming motherboard. I/O board 2153 may be connected to integrated circuit board 2103 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include an operating system (OS), such as a Bally Alpha OS. Base game integrated circuit board 2103 executes a game program that causes integrated circuit board 2103 to play the game. In one embodiment, the game program provides a game having adjustable multi-part indicia. The various components and included devices may be installed with conventionally and/or commercially available components, devices, and circuitry examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 2153 to integrated circuit board 2103 which, in turn, assigns an appropriate number of credits for play in accordance with the game program. The player may further control the operation of the gaming machine by way of other peripherals 2151, for example, to select the amount to wager via electromechanical or touch screen buttons as described above. The game program includes a random number generator to provide a display of randomly selected indicia such as cards at the video display 20. In some embodiments, the random generator may be physically separate from the table 10; for example, it may be part of a central determination host system which provides random game outcomes to the game program. Thereafter, the player may or may not interact with the game through electromechanical or touch screen buttons. Finally, integrated circuit board 2103 under control of the game program and OS compares the final display of indicia to a pay table. The set of possible game outcomes may include a subset of outcomes related to the triggering of a feature game. In the event the displayed outcome is a member of this subset, integrated circuit board 2103, under control of the game program and by way of I/O Board 2153, may cause feature game play to be presented on a feature display.

Predetermined payout amounts for certain outcomes, including feature game outcomes, are stored in a data structure as part of the game program. Such payout amounts are, in response to instructions from integrated circuit board 2103, provided to the player in the form of coins, credits or currency via I/O board 2153 and a pay mechanism, which may be one or more of a credit meter, a coin hopper, a voucher printer, an electronic funds transfer protocol or any other payout means known or developed in the art.

In various embodiments, the game program is stored in a data structure memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The table 10 may access the remote storage device via a network connection, including but not limited to, a local area network connection, a TCP/IP connection, a wireless connection, or any other means for operatively networking components together. Optionally, other data including graphics, sound files and other media data for use with the table 10 are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the table 10 using USB, serial or Ethernet connections. Each of the respective devices may have upgrades to their firmware utilizing these connections.

GMU 2107 includes an integrated circuit board and GMU processor and memory including coding for network communications, such as the G2S (game-to-system) protocol from the Gaming Standards Association, Las Vegas, Nev., used for system communications over the network. As shown, GMU 2107 may connect to card reader 2155 (shown as 32 in FIG. 1B) through bus 2157 and may thereby obtain player card information and transmit the information over the network through bus 2141. Gaming activity information may be transferred by the integrated circuit board 2103 to GMU 2107 where the information may be translated into a network protocol, such as S2S, for transmission to a server, such as a player tracking server, where information about a player's playing activity may be stored in a designated server database.

PIB 2109 includes an integrated circuit board, PID processor, and memory which includes an operating system, such as Windows CE, a player interface program which may be executable by the PID processor together with various input/output (I/O) drivers for respective devices which connect to PIB 2109, such as player interface devices 2111, and which may further include various games or game components playable on PIB 2109 or playable on a connected network server and PIB 2109 is operable as the player interface. PIB 2109 connects to card reader 2155 through bus 2123, display 2159 through video decoder 2161 and bus 2121, such as an LVDS or VGA bus.

As part of its programming, the PID processor executes coding to drive display 2159 and provide messages and information to a player. Touch screen circuitry interactively connects display 2159 (video display 20 in FIG. 1A) and video decoder 2161 to PIB 2109, such that a player may input information and cause the information to be transmitted to PIB 2109 either on the player's initiative or responsive to a query by PIB 2109. Additionally soft keys 2165 connect through bus 2117 to PIB 2109 and operate together with display 2159 (video display 20 in FIG. 1A) to provide information or queries to a player and receive responses or queries from the player. PIB 2109, in turn, communicates over the CMS/SMS network through Ethernet switch 2131 and busses 2135, 2139 and with respective servers, such as a player tracking server.

Player interface devices 2111 are linked into the virtual private network of the system components in gaming table 10. The system components include the iView processing board and game monitoring unit (GMU) processing board. These system components may connect over a network to the slot management system (such as a commercially available Bally SDS/SMS) and/or casino management system (such as a commercially available Bally CMP/CMS). The iView apparatus provides a system interface for the player and for the display of system information to the player. This information and system interface may be displayed at a separate display at each player station 24a-d or at designated real estate at the video display 20 through a video switcher and touch router system as disclosed in Kelly et al U.S. Pat. No. 8,241,123 filed Jan. 8, 2009 and titled “Video Switcher and Touch Router Method for a Gaming Machine” the disclosure of which is incorporated by reference or similar technologies.

The GMU system component has a connection to the game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iView™ processing board and game monitoring unit (GMU) processing board. The GMU and iView™ can combined into one like the commercially available Bally GTM iView device. This device may have a video mixing technology to mix the EGM processor's video signals with the iView display onto the top box monitor or any monitor on the gaming device.

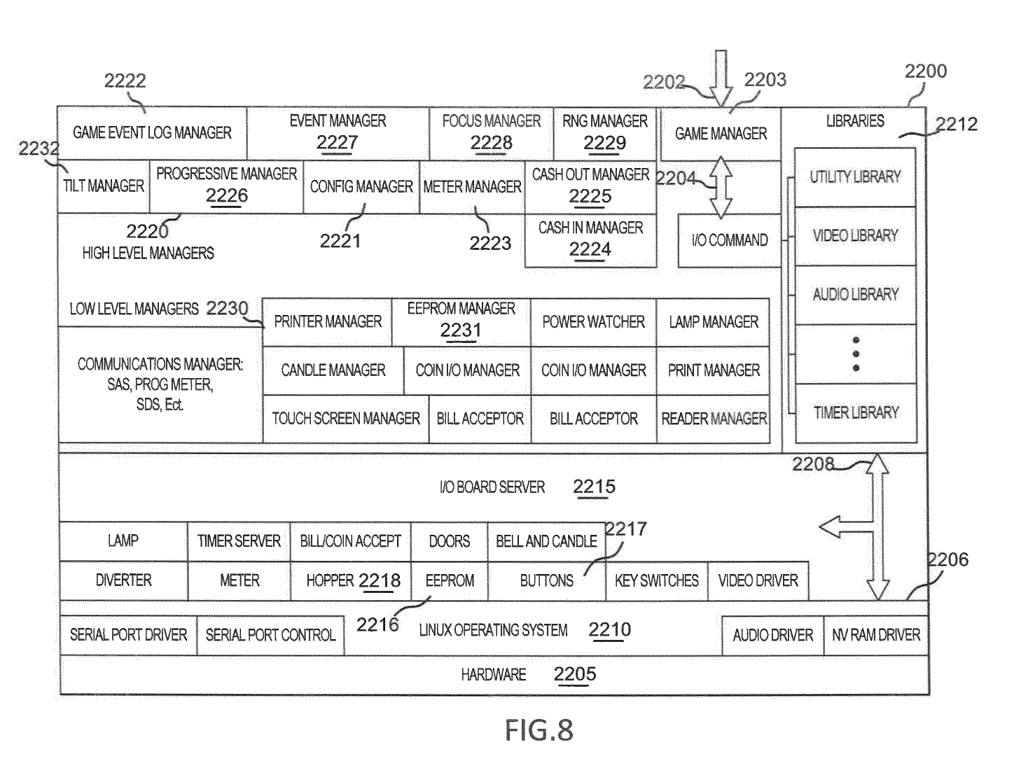

In accordance with one or more embodiments, FIG. 8 is a functional block diagram of a gaming kernel 2200 of a game program under control of the game integrated circuit board 2103. The game program uses gaming kernel 2200 by calling into application programming interface (API) 2202, which is part of game manager 2203. The components of game kernel 2200 as shown in FIG. 22 are only illustrative, and should not be considered limiting. For example, the number of managers may be changed, additional managers may be added or some managers may be removed without deviating from the scope and spirit of the invention.

As shown in the example, there are three layers: a hardware layer 2205; an operating system layer 2210, such as, but not limited to, Linux; and a game kernel layer 2200 having game manager 2203 therein. In one or more embodiments, the use of a standard operating system 2210, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 2200 executes at the user level of the operating system 2210, and itself contains a major component called the I/O Board Server 2215. To properly set the bounds of game application software (making integrity checking easier), all game applications interact with gaming kernel 2200 using a single API 2202 in game manager 2203. This enables game applications to make use of a well-defined, consistent interface, as well as making access points to gaming kernel 2200 controlled, where overall access is controlled using separate processes.

For example, game manager 2203 parses an incoming command stream and, when a command dealing with I/O comes in (arrow 2204), the command is sent to an applicable library routine 2212. Library routine 2212 decides what it needs from a device, and sends commands to I/O Board Server 2215 (see arrow 2208). A few specific drivers remain in operating system 2210's kernel, shown as those below line 2206. These are built-in, primitive, or privileged drivers that are (i) general (ii) kept to a minimum and (iii) are easier to leave than extract. In such cases, the low-level communications is handled within operating system 2210 and the contents passed to library routines 2212.

Thus, in a few cases library routines may interact with drivers inside operating system 2210, which is why arrow 2208 is shown as having three directions (between library utilities 2212 and I/O Board Server 2215, or between library utilities 2212 and certain drivers in operating system 2210). No matter which path is taken, the logic needed to work with each device is coded into modules in the user layer of the diagram. Operating system 2210 is kept as simple, stripped down, and common across as many hardware platforms as possible. The library utilities and user-level drivers change as dictated by the table 10 in which it will run. Thus, each table 10 may have a game integrated circuit board 2103 connected to a unique, relatively dumb, and as inexpensive as possible I/O adapter board 2140, plus a gaming kernel 2200 which will have the table-unique library routines and I/O Board Server 2215 components needed to enable game applications to interact with the table 10. Note that these differences are invisible to the game application software with the exception of certain functional differences (i.e., if a table has stereo sound, the game application will be able make use of API 2202 to use the capability over that of a table having traditional monaural sound).

Game manager 2203 provides an interface into game kernel 2200, providing consistent, predictable, and backwards compatible calling methods, syntax, and capabilities by way of game application API 2202. This enables the game developer to be free of dealing directly with the hardware, including the freedom to not have to deal with low-level drivers as well as the freedom to not have to program lower level managers 2230, although lower level managers 2230 may be accessible through game manager 2203's interface 2202 if a programmer has the need. In addition to the freedom derived from not having to deal with the hardware level drivers and the freedom of having consistent, callable, object-oriented interfaces to software managers of those components (drivers), game manager 2203 provides access to a set of upper level managers 2220 also having the advantages of consistent callable, object-oriented interfaces, and further providing the types and kinds of base functionality required in casino-type games. Game manager 2203, providing all the advantages of its consistent and richly functional interface 2202 as supported by the rest of game kernel 2200, thus provides a game developer with a multitude of advantages.

Game manager 2203 may have several objects within itself, including an initialization object (not shown). The initialization object performs the initialization of the table 10, including other objects, after game manager 2203 has started its internal objects and servers in appropriate order. In order to carry out this function, the kernel's configuration manager 2221 is among the first objects to be started; configuration manager 2221 has data needed to initialize and correctly configure other objects or servers.

The upper level managers 2220 of game kernel 2200 may include game event log manager 2222 which provides, at the least, a logging or logger base class, enabling other logging objects to be derived from this base object. The logger object is a generic logger; that is, it is not aware of the contents of logged messages and events. The log manager's (1622) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 2223 manages the various meters embodied in the game kernel 2200. This includes the accounting information for the table 10 and game play. There are multiple hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 2223 receives its initialization data for the meters, during start-up, from configuration manager 2221. While running, the cash in (1624) and cash out (1625) managers call the meter manager's (1623) update functions to update the meters. Meter manager 2223 will, on occasion, create backup copies of the soft meters by storing the soft meters' readings in EEPROM. This is accomplished by calling and using EEPROM manager 2231.

In accordance with still other embodiments, progressive manager 2226 manages progressive games playable from the table 10. Event manager 2227 is generic, like log manager 2222, and is used to manage various table events. Focus manager 2228 correlates which process has control of various focus items. Tilt manager 2232 is an object that receives a list of errors (if any) from configuration manager 2221 at initialization, and during game play from processes, managers, drivers, etc. that may generate errors. Random number generator manager 2229 is provided to allow easy programming access to a random number generator (RNG), as a RNG is required in virtually all casino-style (gambling) games. RNG manager 2229 includes the capability of using multiple seeds.

In accordance with one or more embodiments, a credit manager object (not shown) manages the current state of credits (cash value or cash equivalent) at the table 10 for each player station 24a-d, including any available winnings, and further provides denomination conversion services. Cash out manager 2225 has the responsibility of configuring and managing monetary output devices. During initialization, cash out manager 2225, using data from configuration manager 2221, sets the cash out devices correctly and selects any selectable cash out denominations. During play, a game application may post a cash out event through the event manager 2227 (the same way all events are handled), and using a call-back posted by cash out manager 2225, cash out manager 2225 is informed of the event. Cash out manager 2225 updates the credit object, updates its state in non-volatile memory, and sends an appropriate control message to the device manager that corresponds to the dispensing device. As the device dispenses dispensable media, there will typically be event messages being sent back and forth between the device and cash out manager 2225 until the dispensing finishes, after which cash out manager 2225, having updated the credit manager and any other game state (such as some associated with meter manager 2223) that needs to be updated for this set of actions, sends a cash out completion event to event manager 2227 and to the game application thereby. Cash in manager 2224 functions similarly to cash out manager 2225, only controlling, interfacing with, and taking care of actions associated with cashing in events, cash in devices, and associated meters and crediting.

In a further example, in accordance with one or more embodiments, I/O server 2215 may write data to the table 10 EEPROM memory, which is located at the table 10 and holds meter storage that must be kept even in the event of power failure. Game manager 2203 calls the I/O library functions to write data to the EEPROM. The I/O server 2215 receives the request and starts a low priority EEPROM thread 2216 within I/O server 2215 to write the data. This thread uses a sequence of 8 bit command and data writes to the EEPROM device to write the appropriate data in the proper location within the device. Any errors detected will be sent as IPC messages to game manager 2203. All of this processing is asynchronous.

In accordance with one embodiment, button module 2217, within I/O server 2215, polls (or is sent) the state of buttons every 2 ms. These inputs are debounced by keeping a history of input samples. Certain sequences of samples are required to detect a button was pressed, in which case the I/O server 2215 sends an inter-process communication event to game manager 2203 that a button was pressed or released. In some embodiments, the table 10 may have intelligent distributed I/O which debounces the buttons, in which case button module 2217 may be able to communicate with the remote intelligent button processor to get the button events and simply relay them to game manager 2203 via IPC messages. In still another embodiment, the I/O library may be used for pay out requests from the game application. For example, hopper module 2218 must start the hopper motor, constantly monitor the coin sensing lines of the hopper, debounce them, and send an IPC message to the game manager 2203 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application Ser. No. 60/313,743, entitled “Form Fitting Upgrade Board Set For Existing Game Cabinets,” filed Aug. 20, 2001; said patent and provisional are both fully incorporated herein by explicit reference.

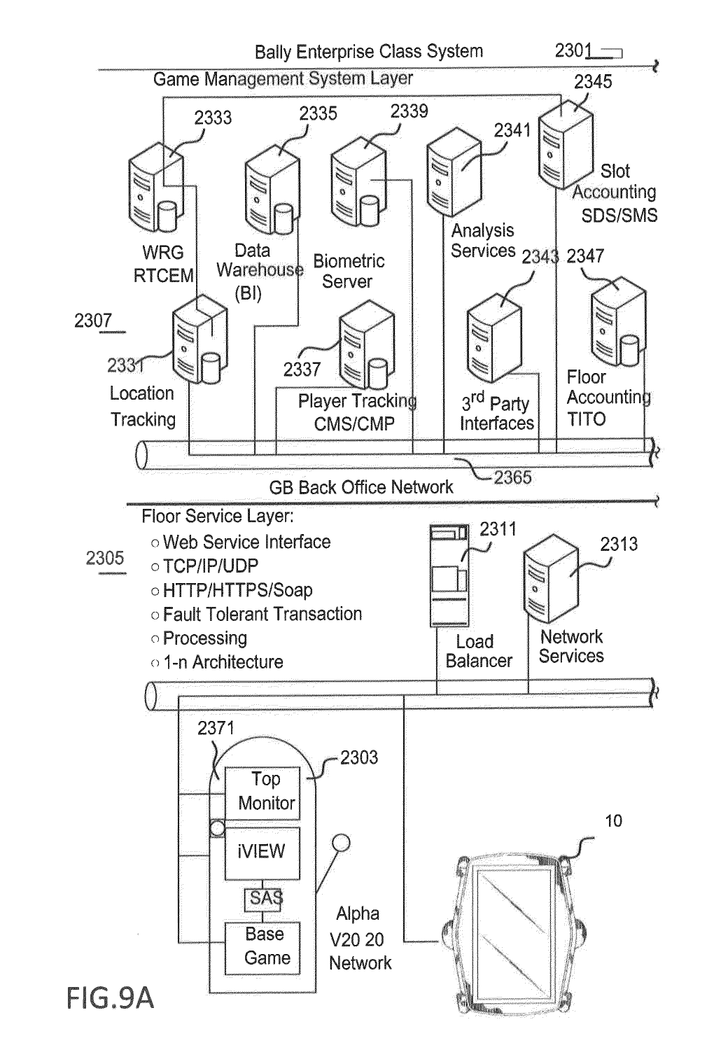

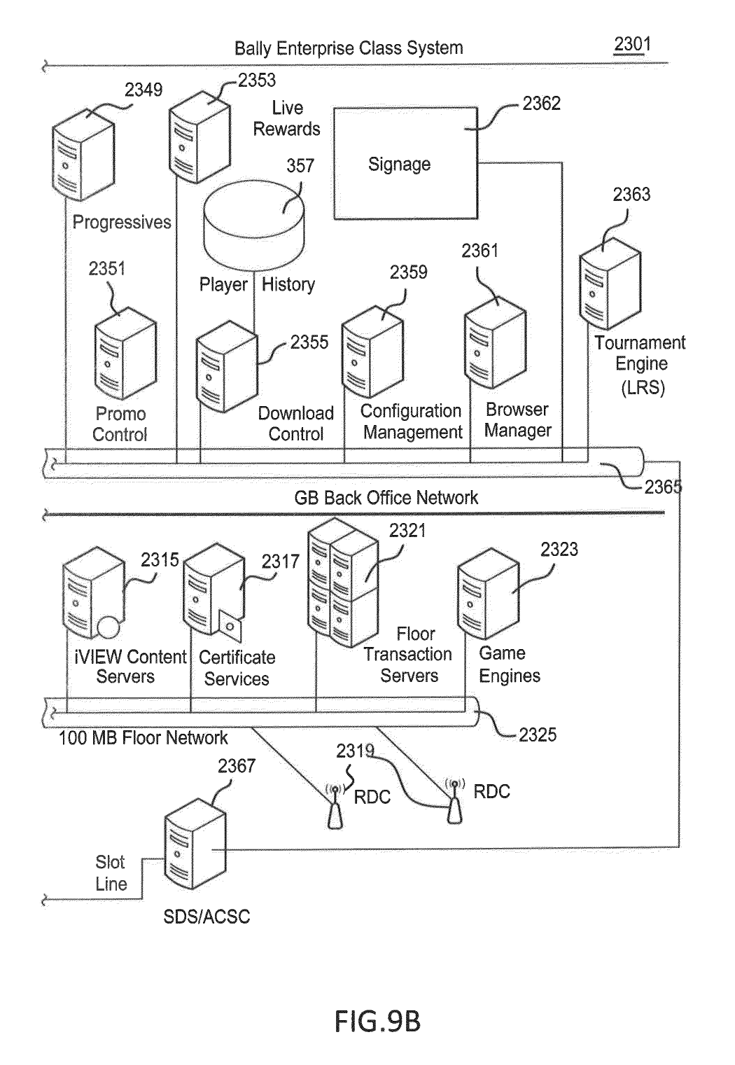

Referring to FIGS. 9A and 9B, enterprise gaming system 2301 is shown in accordance with one or more embodiments. Enterprise gaming system 2301 may include one casino or multiple locations and generally includes a network of gaming machines 2303 and one or more tables 10, floor management system (SMS) 2305, and casino management system (CMS) 2307. SMS 2305 may include load balancer 2311, network services servers 2313, player interface (iView) content servers 2315, certificate services server 2317, floor radio dispatch receiver/transmitters (RDC) 2319, floor transaction servers 2321 and game engines 2323, each of which may connect over network bus 2325 to gaming machines 2303. CMS 2307 may include location tracking server 2331, WRG RTCEM server 2333, data warehouse server 2335, player tracking server 2337, biometric server 2339, analysis services server 2341, third party interface server 2343, slot accounting server 2345, floor accounting server 2347, progressives server 2349, promo control server 2351, feature game (such as Bally Live Rewards) server 2353, download control server 2355, player history database 2357, configuration management server 2359, browser manager 2361, tournament engine server 2363 connecting through bus 2365 to server host 2367 and gaming machines 2303. The various servers, gaming machines 2303 and tables 10 may connect to the network with various conventional network connections (such as, for example, USB, serial, parallel, RS485, Ethernet). Additional servers which may be incorporated with CMS 2307 include a responsible gaming limit server (not shown), advertisement server (not shown), and a control station server (not shown) where an operator or authorized personnel may select options and input new programming to adjust each of the respective servers and gaming machines 2303. SMS 2305 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 2303 and tables 10 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 2307 and/or SMS 2305 servers and devices, firmware, media, operating systems, and configurations may be downloaded to the system components of respective gaming machines/tables for upgrading or managing floor content and offerings in accordance with operator selections or automatically depending upon CMS 2307 and SMS 2305 master programming. The data and programming updates to gaming machines 2303/tables 10 are authenticated using conventional techniques prior to install on the system components.

The game as described herein with reference to FIGS. 1A and 2-6C may be implemented on mobile devices either through a downloaded application (APP) or through a streamed connection with one or more servers. Where permitted by regulations play may be on a pay-to-play (P2P) basis where the player actually wagers value or on a play-for-fun (P4F) basis where the player wagers fictional credits.

In an embodiment the video display 20 may display historical outcomes for a series of games. For example, at a location in the video real estate a histogram may show the last 20 highest awards to attract players. The histogram may also display other information such as winning streaks, e.g. the longest streak with at least one winning award for all pay lines.

In an embodiment the symbols are not revealed before the spin of the wheels 40a-e and instead are revealed during or after the spin. In an embodiment the symbols on the wheels 40a-e may be revealed one wheel at a time to also build anticipation. Some symbols such as the Jokers in the game described, may be revealed separately such as being revealed first. The symbols may be displayed in a manner of a fan. The wheels 40a-e may be controlled to spin clockwise or counter-clockwise. The wheels 40a-e may start spinning simultaneously, sequentially or randomly.

In an embodiment the spin duration and/or spin time is configurable or randomly determined so players cannot time the spins and to build anticipation.

In an embodiment the game may also be played with shared or community symbols. For example, two additional playing cards may be displayed at the display 20 and winning outcomes are measured by the five playing cards on a wagered upon pay line plus the two community cards based upon the best five card Poker holding from the seven cards. This game mechanic is reminiscent of Seven Card Stud in Poker. The game may also be configured as a deuces Wild game.

In an embodiment the play lines may be other than radial such as offset radial or the line which would be defined on the wheels 40a-e to advise the players of the pay line configurations.

Although the description above contains many specificities, these should not be construed as limiting the scope of the invention but as merely providing an illustration of the presently preferred embodiment of the invention.

1. A table for providing a shared gaming experience to a plurality of players comprising:
said table includes a support base and a table top arranged substantially horizontal;
a large, shared polygonal touch screen video display disposed at said table top defining at each of at least two opposing margins thereof video real estate for a displayed player station, each displayed player station arranged to be oriented for a player at said player station;
said touch screen video display including defined video game display real estate apart from said player stations for displaying a shared game;
said each displayed player station displaying one or more touch input buttons for a player to wager upon and interact with said shared game ; and
a game controller configured to control said video display to display outcomes for said shared game and in communication with each player station to receive said wager inputs and discriminate between wager inputs at different player stations.

2. The table of claim 1 comprising said touch screen video display defines proximate each corner said video real estate for display each of four player stations.

3. The table of claim 1 comprising said controller is configured to control the shared display to display at said video game real estate a concentric wheel game where each wheel displays playing cards and displayed playing cards along one or more radial positions defines outcomes for the game.

4. The table of claim 3 comprising said controller is configured to control the shared display to display at said video game real estate a concentric wheel game include five concentric wheels.

5. The table game of claim 4 comprising said controller is configured to control the shared display to display at said video game real estate a concentric wheel game include five concentric wheels whereby radial positions for said wheels define Poker based outcomes.

6. A table for providing a shared gaming experience to a plurality of players comprising:
said table includes a support base and a table top arranged substantially horizontal;
a large, shared polygonal touch screen video display disposed at said table top defining at each of at least two opposing margins thereof video real estate for a displayed player station, each displayed player station arranged to be oriented for a player at said player station and spaced from the adjoining player station;
said touch screen video display including defined video game display real estate apart from said player stations for displaying a shared game;
said each displayed player station displaying one or more touch input buttons for a player to wager upon and interact with said shared game; and
a game controller configured to control said video display to display a concentric wheel game where each wheel displays playing cards and displayed playing cards along one or more radial positions defines outcomes for the game.
